(19) United States
(12) Patent Application Publication
(10) Pub. No.: US 2025/0044963 A1
(43) Pub. Date: Feb. 6, 2025

(54) METHOD FOR ALLOCATING MEMORY, COMPUTER DEVICE AND STORAGE MEDIUM

(71) Applicant: Beijing Volcano Engine Technology Co., Ltd., Beijing (CN)

(72) Inventors: Peng LIU, Beijing (CN); Wei TANG, Los Angeles, CA (US); Fei LIU, Los Angeles, CA (US); Guojun LI, Beijing (CN); Peng XU, Los Angeles, CA (US)

(21) Appl. No.: 18/784,910

(22) Filed: Jul. 25, 2024

(30) Foreign Application Priority Data
Aug. 1, 2023 (CN) 202310961423.9

(51) Int. Cl. G06F 3/06

(52) U.S. Cl. CPC G06F 3/0631; G06F 3/0604; G06F 3/0673

(57) ABSTRACT

The present disclosure provides a method for allocating memory, computer device and storage medium. The method can achieve allocation of hard disk memory to a target application through use of free memory information of the hard disk memory and size information written into a first storage space. In addition, the free memory information of the hard disk memory is stored in system memory, and during allocation for the hard disk memory, the free memory information of the hard disk memory is directly read from the system memory.

### CROSS-REFERENCE TO RELATED APPLICATIONS

This application claims the priority of Chinese Patent Application No. 202310961423.9 filed on Aug. 1, 2023, which is incorporated herein by reference in its entirety.

### TECHNICAL FIELD

Embodiments of the present disclosure relate to a method for allocating memory, computer device and storage medium.

### BACKGROUND

Solid-State Drives (SSD) are a class of nonvolatile storage devices that use flash memory chips for data storage. Compared to traditional hard disk drives, SSDs have no moving parts and utilize electronic storage technologies, thus achieving faster and more stable reading and writing. Typically, SSD is equipped with hard disk memory that usually serves only as a data transit area inside the SSD. Since the communication rate between the SSD and the central processing unit is not as high as the communication rate between system memory and the SSD, memory buffers in the SSD are generally not used to provide memory for applications.

### SUMMARY

Embodiments of the present disclosure at least provide a method for allocating memory, a computer device and a storage medium.

An embodiment of the present disclosure provides a method for allocating memory, including:
reading, in response to an allocation request for a hard disk memory sent by a target application, free memory information of the hard disk memory from a system memory;
determining, based on the free memory information of the hard disk memory, a first storage space to be allocated from the hard disk memory;
determining a second storage space corresponding to the first storage space in the hard disk memory based on initial address information of the first storage space, and writing size information of the first storage space into the second storage space; and
sending the initial address information corresponding to the first storage space to the target application, such that the target application accesses the second storage space based on the initial address information and uses the first storage space based on the size information written into the second storage space and the initial address information.

The embodiment of the present disclosure also provides a method for allocating memory, including:
sending an allocation request for a hard disk memory to a memory allocator;
receiving initial address information of a first storage space returned by the memory allocator, wherein the first storage space is determined by the memory allocator based on a free memory information of the hard disk memory read from a system memory;
accessing a second storage space corresponding to the first storage space based on the initial address information of the first storage space, and reading size information of the first storage space from the second storage space, wherein the size information of the first storage space is written into the second storage space by the memory allocator; and
using the first storage space based on the initial address information and the size information.

The embodiment of the present disclosure also provides an apparatus for allocating memory, including:
a reading module configured to read, in response to an allocation request for a hard disk memory sent by a target application, free memory information of the hard disk memory from a system memory;
a first determining module configured to determine, based on the free memory information of the hard disk memory, a first storage space to be allocated from the hard disk memory;
a writing module configured to determine a second storage space corresponding to the first storage space in the hard disk memory based on initial address information of the first storage space, and write size information of the first storage space into the second storage space; and
a first sending module configured to send the initial address information corresponding to the first storage space to the target application, such that the target application accesses the second storage space based on the initial address information and uses the first storage space based on the size information written into the second storage space and the initial address information.

The embodiment of the present disclosure also provides an apparatus for allocating memory, including:
a second sending module configured to send an allocation request for a hard disk memory to a memory allocator;
a receiving module configured to receive initial address information of a first storage space returned by the memory allocator, wherein the first storage space is determined by the memory allocator based on a free memory information of the hard disk memory read from a system memory;
a reading module configured to access a second storage space corresponding to the first storage space based on the initial address information of the first storage space, and read size information of the first storage space from the second storage space, wherein the size information of the first storage space is written into the second storage space by the memory allocator; and
a using module configured to use the first storage space based on the initial address information and the size information.

The embodiment of the present disclosure also provides an electronic device, at least one processor and at least one memory, wherein machine-readable instructions executable by the at least one processor are stored in the at least one memory, the at least one processor is configured for executing the machine-readable instructions stored in the at least one memory, and when the machine-readable instructions are executed by the at least one processor, the processor executes any of the methods provided by the embodiments of the present disclosure.

An optional implementation of the present disclosure also provides a computer readable storage medium, wherein the computer readable storage medium has a computer program stored thereon, and when the computer program is executed by a computer device, the computer device executes any of the methods provided by the embodiments of the present disclosure.

For the description of the effects of the above memory allocation method, apparatus, electronic device and storage medium, reference is made to the depiction of the above memory allocation method and no further description is given here.

It should be understood that the above general description and the detailed description hereinbelow are merely illustrative and explanatory, and do not limit the technical solution of the present disclosure.

To make the aforesaid objects, features and advantages of the present disclosure more obvious and comprehensible, preferred embodiments are provided hereinafter and the detailed description thereof is given in conjunction with the accompanying drawings.

### BRIEF DESCRIPTION OF DRAWINGS

In order to provide a clearer description of the technical solutions of the embodiments of the present disclosure, the drawings that need to be used in the embodiments will be briefly depicted below and the drawings here are incorporated into the description and form part of the present description. These drawings show the embodiments that conform to the present disclosure, and are used, together with the description, to illustrate the technical solutions of the present disclosure. It will be appreciated that the following drawings only show some embodiments of the present disclosure and shall not be considered as limiting the scope, and that for those ordinary skilled in the art, other relevant drawings may also be attained from these drawings without creative efforts.

FIG. 1 shows a flow diagram of a memory allocation method according to the embodiments of the present disclosure;

FIG. 2 shows a schematic diagram of determination of storage spaces via a Heap memory allocator according to the embodiments of the present disclosure;

FIG. 3 shows a schematic diagram of header setting by CMB/PMR subsequent to determination of storage spaces according to the embodiments of the present disclosure;

FIG. 4 shows a schematic diagram of a SPDK memory allocator according to the embodiments of the present disclosure;

FIG. 5 shows a schematic diagram of the main structure of a buddy system under Linux kernel according to the embodiments of the present disclosure;

FIG. 6 shows a flow diagram of another memory allocation method according to the embodiments of the present disclosure;

FIG. 7 shows a schematic diagram of a memory allocation apparatus according to the embodiments of the present disclosure;

FIG. 8 shows a schematic diagram of another memory allocation apparatus according to the embodiments of the present disclosure;

FIG. 9 shows a schematic diagram of a computer device according to the embodiments of the present disclosure; and

FIG. 10 shows a schematic diagram of another computer device according to the embodiments of the present disclosure.

### DETAILED DESCRIPTION

For a better clarity of the objects, technical solutions and advantages of the embodiments of the present disclosure, the technical solutions in the embodiments of the present disclosure will be clearly and thoroughly described below in conjunction with the accompanying drawings in the embodiments of the present disclosure. It is obvious that the described embodiments are only some embodiments of the present disclosure, not all of them. The components of the embodiments of the present disclosure, which are typically described and shown here, may be arranged and designed in a variety of different configurations. Therefore, the following detailed description of the embodiments of the present disclosure is not intended to limit the scope of the claimed disclosure, but merely indicates the selected embodiments of the present disclosure. Based on the embodiments of the present disclosure, all other embodiments obtained by those skilled in the art without creative efforts fall within the scope of the present disclosure.

In addition, the terms “first”, “second”, etc., in the description and claims and the above-mentioned accompanying drawings in the embodiments of the present disclosure are used to distinguish similar objects, and do not need to be used to describe a specific order or priority order. It should be understood that the data thus used is interchangeable where appropriate, so that the embodiments described here can be implemented in an order other than what is illustrated or described here.

References to “a plurality of or several” herein refer to two or more than two. “And/or” depicts the correlation relationship between correlated objects, indicating that there can be three relationships. For example, A and/or B may be indicative of three cases: A alone, both A and B, and B alone. The character “/” generally indicates that the former and latter correlated objects are in an OR relationship.

Researches have unveiled that if hard disk memory is utilized to allocate memory for applications, then the central processing unit is required to read the free memory information of the hard disk memory from the hard disk memory, the free memory information needs to be transmitted to the central processing unit through a PCIE bus during the reading process, and yet the PCIE bus has a low transmission rate, resulting in inefficient hard disk memory allocation.

Based on the above researches, provided in the embodiments of the present disclosure is a memory allocation method that achieves allocation of hard disk memory to target applications through use of free memory information of the hard disk memory and size information written into a first storage space. In addition, the free memory information of the hard disk memory is stored in system memory that has higher access speed, and during allocation for the hard disk memory, the free memory information of the hard disk memory is directly read from the system memory having higher access speed, with no need of acquiring the free memory information from the hard disk memory that is relatively slow in access. In this way, the communication time required for memory allocation is shortened and the efficiency of memory allocation is improved. In addition, the responding speed of the target applications and user experience can also be improved by quickly determining available storage spaces in the hard disk memory.

The defects that exist in the above solution are the result of the inventor's practice and elaborative researches. Therefore, the process of discovering the above problems, as well as the following solutions proposed by the present disclosure with respect to the above problems, shall all be regarded as the inventor's contributions to the present disclosure.

It should be noted that similar reference numbers and letters indicate similar items in the drawings below. Hence, once a certain item is defined in one drawing, it does not need to be further defined and explained in subsequent drawings.

It should be noted that the specific terms mentioned in the embodiments of the present disclosure include:
1. SSD (Solid-State Drive) is a hard disk made of solid-state electronic memory chip arrays.
2. NVMe (Non-Volatile Memory Express) is a high-performance, non-uniform-memory-access-optimized, highly-scalable storage protocol.
3. CMB (Controller Memory Buffer) refers to a read/write storage buffer inside an SSD controller. This memory buffer can be used to store some (or all) of NVMe queues, thereby reducing latency and improving host performance.
4. PMR (Persistent Memory Region) refers to a read-write memory region inside the SSD controller. This region has the characteristic that after power cutoff, controller resetting and PMR enable/disable switching, data written into the PMR still remains and is protected by internal capacitors.
5. PCIe (Peripheral Component Interconnect express) is a bus standard that is primarily used to augment data throughput in computer system buses and to raise the communication speed of devices.
6. DDR is short for DDR SDRAM (Double Data Rate Synchronous Dynamic Random Access Memory) and refers to computer memory, in particular system memory in the present embodiment.

For a better understanding of the present embodiment, a memory allocation method disclosed in the embodiments of the present disclosure will first be described in details. The execution entity for the memory allocation method provided in the embodiments of the present disclosure is generally a computer device with certain computing capabilities. For example, this computer equipment includes: a terminal device or a server or other processing devices. In some possible implementations, this memory allocation method can be implemented in such a way that a processor invokes computer-readable instructions stored in a memory.

With reference to FIG. 1, which is a flow diagram of the memory allocation method according to the embodiments of the present disclosure, the method includes the steps S101 to S104. The execution entity for this method may be a memory allocator running on a central processing unit, wherein:

S101: reading, in response to an allocation request for hard disk memory sent by a target application, free memory information of the hard disk memory from system memory.

Specifically, the target application may refer to an application requiring memory allocation, and the target application may invoke an allocation function.

The above allocation request may be sent by the target application and is used for requesting memory from the system. The allocation request may be the above allocation function, and the allocation function may run on the CPU.

The above system memory may be a DRAM (Dynamic Random Access Memory), i.e. memory that can communicate directly with the CPU. The free memory information may indicate that memory spaces in a free state in the hard disk memory can be stored in the system memory in the form of free lists.

In this step, after the CPU receives the allocation request for the hard disk memory sent by the target application, an interruption may be triggered, and as indicated by the allocation request, the free memory information of the hard disk memory is read from the system memory.

The timing at which the interruption is triggered may be an immediate interruption upon reception of the allocation request, or an interruption that follows completion of higher-priority tasks according to current task progresses.

Based on the above implementation, with the free memory information of the hard disk memory being read from the system memory, the communication time required for memory allocation can be shortened and the efficiency of memory allocation can be improved.

In the embodiments of the present disclosure, memory allocation is performed for hard disk memory, i.e. a read/write storage buffer in the hard disk. The size of the hard disk memory may be set according to actual conditions (e.g., the size of a to-be-allocated memory space required for the application). Exemplarily, to enable use of the above hard disk memory by more applications, the hard disk memory with a larger capacity may be set, e.g., SSD with a storage capacity of 1 TB and 1 GB hard disk memory. This hard disk memory can support DDR4 architecture. By accessing a free storage memory of the read/write storage buffer in the hard disk that is allocated to the target application by the system memory, the responding speed of the target application can be increased and the communication time for memory allocation can be reduced.

The above hard disk memory may be the read/write storage buffer in the hard disk, and the read/write storage buffer may include a controller memory buffer (CMB) and/or a persistent memory region (PMR).

The above CMB and PMR media are set inside the hard disk, with data exchange therebetween involving no CPU. Use of the CMB as a read/write buffer for NVMe can ensure that data transmission occurs only inside the hard disk and thus host performance can be improved. In the case that the PMR is used as a read/write buffer for NVMe, writing can be considered successful once data is written to the PMR. Afterwards, PMR data is flashed back to NVMe disks asynchronously, which can reduce writing latency. The PMR is used to store metadata that is highly frequently accessed, and updating for the metadata does not require random disk writing, achieving an improvement in system performances. Use of the above CMB and/or PMR as the hard disk memory can provide faster reading and writing to those applications requiring hard disk reading/writing.

To accomplish allocation of the hard disk memory, the free memory information of the hard disk memory needs to be used. To this end, a free detection may be performed on the hard disk memory before the response to the allocation request for the hard disk memory sent by the target application, the free memory information of the hard disk memory is generated based upon the result of the free detection, and the free memory information is then stored in the system memory for future use at the time of allocation of the hard disk memory.

During specific implementation, the free memory information of the hard disk memory may be generated in different ways. For example, the free memory information of the hard disk memory may be generated in such a way that the entire CMB memory is divided into a plurality of small pieces of memory by different byte sizes such as 32, 64, 128, etc., and the free memory information of identical or similar size is recorded, as a data structure of lists, in a plurality of different lists. For another example, the free memory information of the hard disk memory may also be generated in such a way that instead of dividing the hard disk memory in advance, all the free memory is directly organized in the form of lists. This is not limited by the embodiments of the present disclosure.

By utilizing the above implementation, the free memory information with faster traversing can be generated, and also the free memory information of the hard disk memory can be stored in the system memory having faster access. And during allocation for the hard disk memory, the free memory information of the hard disk memory is directly read from the system memory having higher access speed, with no need of acquiring the free memory information from the hard disk memory that is relatively slow in access. In this way, the communication time required for memory allocation is shortened and the efficiency of memory allocation is improved.

S102: determining, based on the free memory information of the hard disk memory, a first storage space to be allocated from the hard disk memory.

In this step, a plurality of memory spaces that conform to requirement information can be screened out according to the free memory information, and then among the memory spaces that conform to the requirement information, the first storage space to be allocated is screened out.

The above requirement information may be carried by the allocation request and may indicate minimum memory size required, memory type required (such as CMB, PMR), etc.

By utilizing the above implementation, the storage space can be screened out according to the free memory information of the hard disk memory, free memory that conforms to the requirement information can be accurately found, and thus the efficiency and accuracy in memory allocation can be raised.

In a possible implementation, the free memory information of the hard disk memory includes a plurality of lists; the list indicates memory information of various storage spaces in a free state in a continuous memory space.

Specifically, the list is a data structure and data in the list is linearly arranged. In the list, it is convenient to add and delete data. By storing the free memory information of the hard disk memory in the list structure with better dynamic performances (e.g., the starting addresses of all the free memory in the CMB can be stored in the system memory as the list structure), the speed of altering the free memory information of the hard disk memory during memory allocation can be increased, the efficiency of memory allocation can be enhanced, and the responding speed of the target application can be raised.

In order to further increase the efficiency and accuracy in memory allocation, the plurality of lists can be traversed, and the first storage space is screened out from the various storage spaces in the free state based on the memory information of the various traversed storage spaces in the free state and the requirement information indicated by the allocation request.

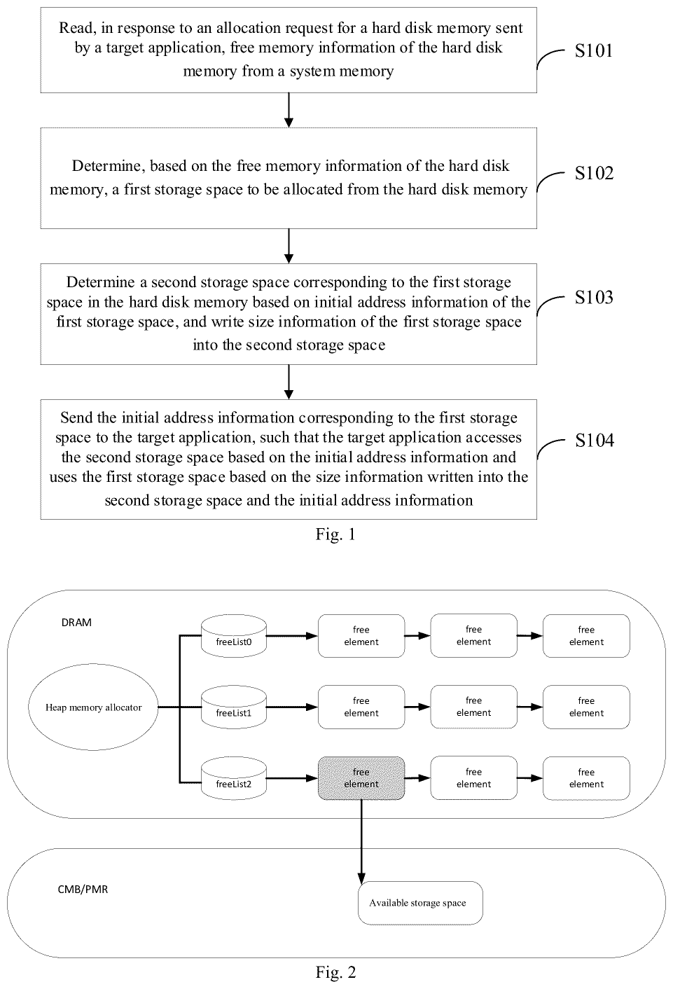

Based on the above implementation, an appropriate storage space can be quickly found according to the requirement information. For example, an appropriate storage space can be determined on the basis of the principle of Best fit, a pointer variable is set up to point to the first node of the list, the memory information of the first storage space in the free state is obtained by accessing the list, the pointer variable is then shifted backwards by one node to obtain the memory information of the second storage space in the free state, and the same action of the pointer variable is repeated until the last node of the list. In this way, the memory information of all the storage spaces in the free state is obtained and among the memory information, the storage space that is closest to the memory size for which the requirement information applies can be found. For example, with reference to FIG. 2, after the plurality of lists in a Heap memory allocator are traversed, the starting address of the storage space that is closest to the memory size for which the requirement information applies is screened out and stored in the first free element of freelist2 of the Heap memory allocator in the system memory.

For another example, on the basis of the principle of Worst fit, a pointer variable is similarly set up to point to the first node of the list, the memory information of the first storage space in the free state is obtained by accessing the list, the pointer variable is then shifted backwards by one node to obtain the memory information of the second storage space in the free state, and the same action of the pointer variable is repeated until the last node of the list. In this way, the memory information of all the storage spaces in the free state is obtained and yet the storage space the size of which matches exactly with allocation requirements cannot be found. As a result, allocation begins from the largest free memory and on the basis of this principle of Worst fit, it is highly possible that the free memory that remains after the memory allocation operation is still large enough to meet future allocation requirements.

With the above implementation, the storage space is screened out by traversing the free memory information of the hard disk memory in the lists, the free memory that is in conformity with the requirement information can be accurately found, and the efficiency and accuracy in memory allocation can be increased.

S103: determining a second storage space corresponding to the first storage space in the hard disk memory based on initial address information of the first storage space, and writing size information of the first storage space into the second storage space.

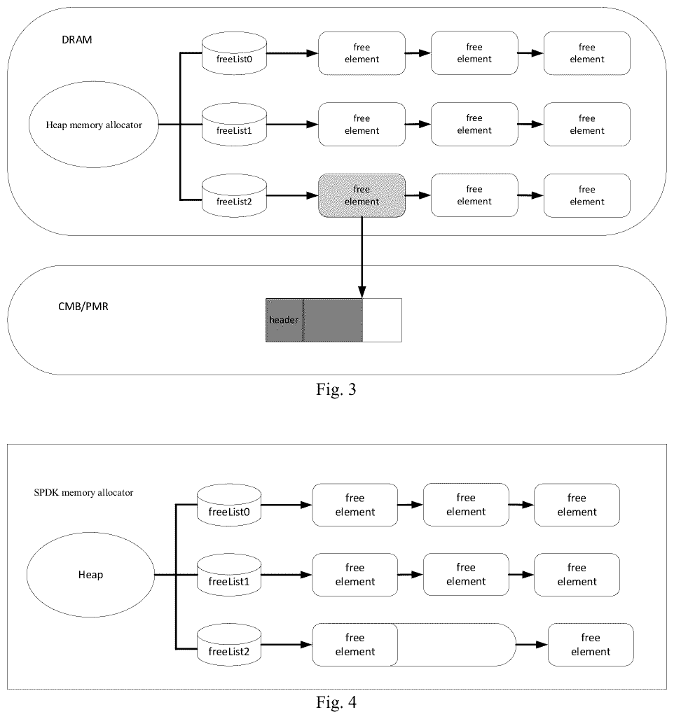

In this step, the initial address information may be absolute address information of the storage space, or relative address information that is obtained from a particular shift on the basis of the starting address of a certain storage space. For example, the initial address information of the first storage space in the hard disk memory PMR may be absolute address 0x0023. Based on the initial address information of the first storage space, the second storage space corresponding to the first storage space is determined in the hard disk memory. For instance, CMB/PMR memory is determined on the basis of the hard disk memory corresponding to the first free element in freelist2 of the Heap memory allocator, and during writing of the size information of the first storage space into the second storage space, as shown in FIG. 3, a header can be set in front of the address information of the CMB/PMR memory to be allocated. This header is used for characterizing the size information of the first storage space.

Exemplarily, the above-mentioned first and second memory spaces may be contiguous in physical memory, and the second memory space may precede the first memory space. This helps the target application utilize the initial address information of the first storage space to deduce the address of the second storage space.

S104: sending the initial address information corresponding to the first storage space to the target application, such that the target application accesses the second storage space based on the initial address information and uses the first storage space based on the size information written into the second storage space and the initial address information.

The initial address information corresponding to the first storage space can be sent to the target application once the size information is written into the second storage space. After obtaining the initial address information of the first storage space, the target application can utilize the initial address information to deduce the address of the second storage space, and access the second storage space to obtain the storage information of the first storage space. Therefore, use of the first storage space is accomplished through the size information and the initial address information.

Thus, by setting the second storage space and writing the size information of the first storage space into the second storage space, the second storage space can be directly read during hard disk memory reclaim so as to learn the size of the first storage space, without querying allocation logs, so higher efficiency is achieved. Furthermore, since memory alignment is required at the time of hard disk memory allocation, the memory space that is actually allocated to an application is typically larger than that required by this application. In this way, it is possible to keep a record of how much hard disk memory is actually allocated, preventing memory fragmentation.

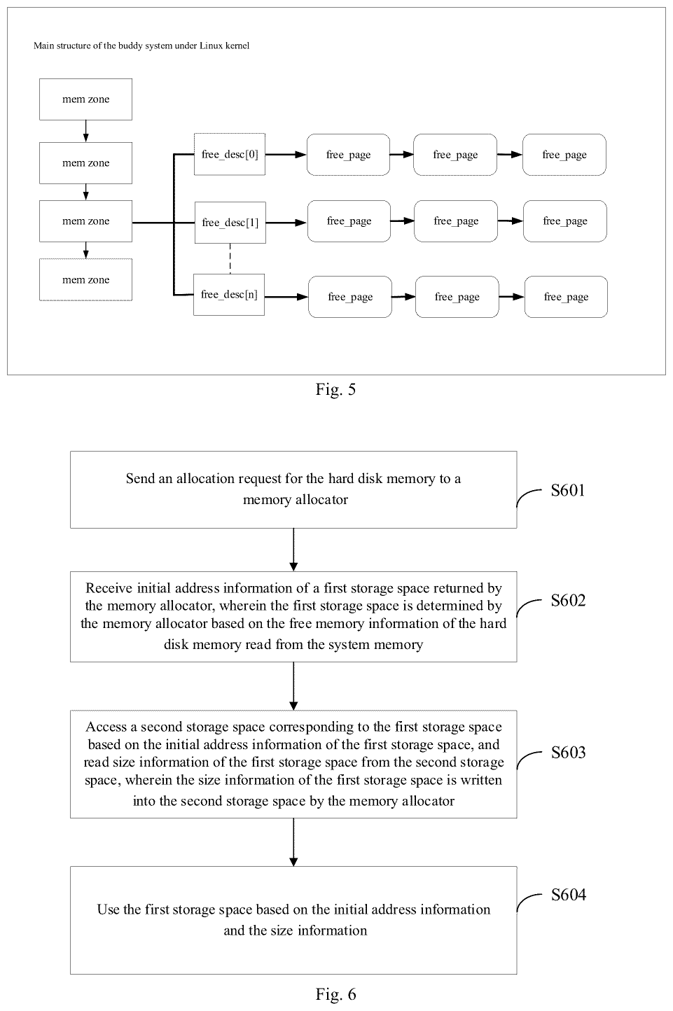

The memory allocation method according to the embodiments of the present disclosure can be implemented using not only an SPDK memory allocator but also a buddy system under Linux kernel. Reference is made to FIG. 4 and FIG. 5, which are a schematic diagram of the SPDK memory allocator according to the embodiments of the present disclosure and a schematic diagram of the main structure of the buddy system under Linux kernel according to the embodiments of the present disclosure, respectively. In the drawings, the free memory information corresponding to the SPDK memory allocator may have a plurality of lists (e.g., freeList0, freeList1, freeList2) representing a large section of free memory space. The list may include a plurality of free elements indicating a small section of free memory space in the large section of free memory space. The free memory information corresponding to the buddy system may have a plurality of mem zones, the mem zones may correspond to a plurality of free page groups (free_desc), and a plurality of free pages (free_page) are included in the page group.

By utilizing the memory allocation method according to the embodiments of the present disclosure, the free memory information of the hard disk memory can be stored in the system memory that has higher access speed, and during allocation for the hard disk memory, the free memory information of the hard disk memory is directly read from the system memory having higher access speed, with no need of acquiring the free memory information from the hard disk memory that is relatively slow in access. In this way, the communication time required for memory allocation is shortened and the efficiency of memory allocation is improved.

As shown in FIG. 6, which is a flow diagram of another memory allocation method according to the embodiments of the present disclosure, the method includes the steps S601 to S604. The execution entity for this method may be a target application, wherein:

S601: sending an allocation request for the hard disk memory to a memory allocator.

In this step, the target application may invoke instructions such as malloc/free in C language, and send the allocation request for the hard disk memory to the memory allocator. This is not limited by the embodiments of the present disclosure.

S602: receiving initial address information of a first storage space returned by the memory allocator, wherein the first storage space is determined by the memory allocator based on the free memory information of the hard disk memory read from system memory.

The target application may receive the initial address information of the first storage space returned by the memory allocator, this initial address information may be determined by the memory allocator, the memory allocator may read the free memory information of the hard disk memory from the system memory and allocate a memory space for the target application according to the free memory information, and the allocated memory space is the first storage space described above.

S603: accessing a second storage space corresponding to the first storage space based on the initial address information of the first storage space, and reading size information of the first storage space from the second storage space, wherein the size information of the first storage space is written into the second storage space by the memory allocator.

In this step, the target application may deduce the address information of the second storage space based on the initial address information of the first storage space, and access the second storage space by utilizing the address information of the second storage space. During specific implementation, the target application may negotiate in advance with the memory allocator how the second storage space is determined, e.g., the initial address information of the first storage space is shifted forwards and the shift amount may be a preset shift amount. In this manner, the target application can have a direct access to the second storage space according to the initial address information of the first storage space.

S604: using the first storage space based on the initial address information and the size information.

In this step, upon learning of the initial address information of the allocated memory and the size information of the allocated memory, the target application can use the allocated memory, i.e. the above-mentioned first storage space, in a normal way.

Those skilled in the art may appreciate that in the above methods of the DETAILED DESCRIPTION, the writing order of various steps does not imply a strict order of execution to form any limitation to the implementation process, and the specific order of execution of various steps shall be determined by their functions and possible internal logics.

Based on the same inventive concept, also provided in the embodiments of the present disclosure are memory allocation apparatuses that correspond to the memory allocation methods. Since the problem-solving principle used by the apparatuses in the embodiments of the present disclosure are similar to those used by the above memory allocation methods in the embodiments of the present disclosure, reference can be made to implementation of the methods for implementation of the apparatuses, and no redundant description is given here.

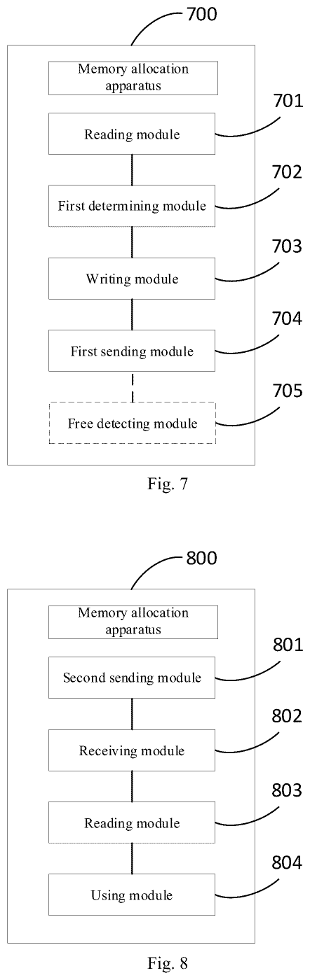

With reference to FIG. 7, which is a schematic diagram of a memory allocation apparatus 700 according to the embodiments of the present disclosure, the apparatus includes: a reading module 701, a first determining module 702, a writing module 703, and a first sending module 704.
a reading module 701 is configured to read, in response to an allocation request for a hard disk memory sent by a target application, free memory information of the hard disk memory from a system memory;
a first determining module 702 is configured to determine, based on the free memory information of the hard disk memory, a first storage space to be allocated from the hard disk memory;
a writing module 703 is configured to determine a second storage space corresponding to the first storage space in the hard disk memory based on initial address information of the first storage space, and write size information of the first storage space into the second storage space; and
a first sending module 704 is configured to send the initial address information corresponding to the first storage space to the target application, such that the target application accesses the second storage space based on the initial address information and uses the first storage space based on the size information written into the second storage space and the initial address information.

In a possible implementation, the hard disk memory includes a read/write storage buffer in a hard disk.

In a possible implementation, the read/write storage buffer includes a controller memory buffer (CMB) and/or a persistent memory region (PMR).

In a possible implementation, the free memory information of the hard disk memory includes a plurality of lists; a list indicates memory information of various storage spaces in a free state in a continuous memory space.

In a possible implementation, the determining, based on the free memory information of the hard disk memory, a first storage space to be allocated from the hard disk memory includes:

traversing the plurality of lists, and screening out the first storage space from various traversed storage spaces in the free state based on memory information of the various traversed storage spaces in the free state and requirement information indicated by the allocation request.

In an optional implementation, the memory allocation apparatus 700 further includes a free detecting module 705,

The free detecting module 705 is configured to before responding to the allocation request for the hard disk memory sent by the target application, perform a free detection on the hard disk memory, and generate the free memory information of the hard disk memory; and store the free memory information in the system memory.

With reference to FIG. 8, which is a schematic diagram of another memory allocation apparatus according to the embodiments of the present disclosure, the apparatus includes: a second sending module 801, a receiving module 802, a reading module 703, and a using module 804.
the second sending module 801 is configured to send an allocation request for a hard disk memory to a memory allocator;
the receiving module 802 is configured to receive initial address information of a first storage space returned by the memory allocator, wherein the first storage space is determined by the memory allocator based on a free memory information of the hard disk memory read from a system memory;
a reading module 803 is configured to access a second storage space corresponding to the first storage space based on the initial address information of the first storage space, and read size information of the first storage space from the second storage space, wherein the size information of the first storage space is written into the second storage space by the memory allocator; and
the using module 804 is configured to use the first storage space based on the initial address information and the size information.

With regard to the description of the processing flows of various modules as well as the interaction flows among various modules in the apparatuses, reference can be made to the relevant descriptions in the above method embodiments, and no redundant description is given here.

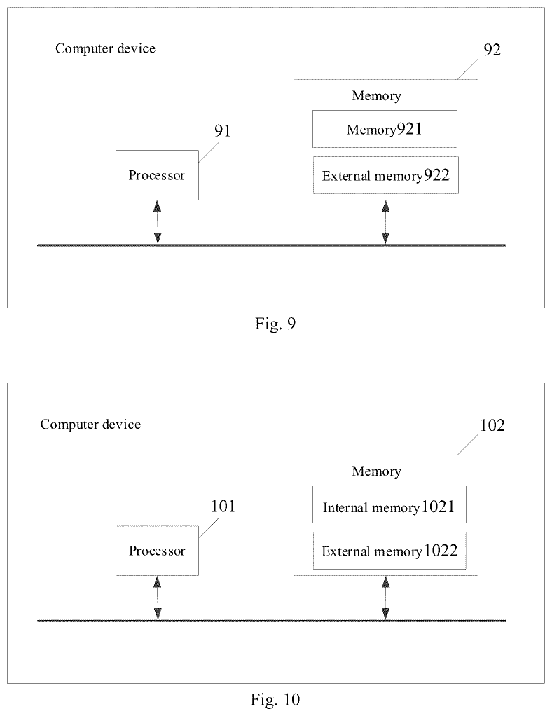

Also provided in the embodiments of the present disclosure is a computer device that, as shown in FIG. 9 which is a structural schematic diagram of the computer device according to the embodiments of the present disclosure, includes:
a processor 91 and a memory 92, wherein machine-readable instructions executable by the processor 91 are stored in the memory 92, the processor 91 is used for executing the machine-readable instructions stored in the memory 92, and when the machine-readable instructions are executed by the processor 91, the processor 91 executes the following steps:
reading, in response to an allocation request for a hard disk memory sent by a target application, free memory information of the hard disk memory from a system memory;
determining, based on the free memory information of the hard disk memory, a first storage space to be allocated from the hard disk memory;
determining a second storage space corresponding to the first storage space in the hard disk memory based on initial address information of the first storage space, and writing size information of the first storage space into the second storage space; and
sending the initial address information corresponding to the first storage space to the target application, such that the target application accesses the second storage space based on the initial address information and uses the first storage space based on the size information written into the second storage space and the initial address information.

In a possible implementation, the hard disk memory includes a read/write storage buffer in a hard disk.

In a possible implementation, the read/write storage buffer includes a controller memory buffer (CMB) and/or a persistent memory region (PMR).

In a possible implementation, the free memory information of the hard disk memory includes a plurality of lists; a list indicates memory information of various storage spaces in a free state in a continuous memory space.

In a possible implementation, the determining, based on the free memory information of the hard disk memory, a first storage space to be allocated from the hard disk memory includes:

traversing the plurality of lists, and screening out the first storage space from various traversed storage spaces in the free state based on memory information of the various traversed storage spaces in the free state and requirement information indicated by the allocation request. In a possible implementation, the processor 91 is also used to:

before responding to the allocation request for the hard disk memory sent by the target application, perform a free detection on the hard disk memory, and generate the free memory information of the hard disk memory; and store the free memory information in the system memory.

The above memory 92 includes a memory 921 and an external memory 922; the memory 921 here is also called the internal memory, which is used for temporarily storing operational data in the processor 91 as well as data exchanged with the external memory 922 such as hard disks, and the processor 91 exchanges data with the external memory 922 through the memory 921.

Also provided in the embodiments of the present disclosure is another computer device that, as shown in FIG. 10 which is a structural schematic diagram of the computer device according to the embodiments of the present disclosure, includes:

a processor 101 and a memory 102, wherein machine-readable instructions executable by the processor 101 are stored in the memory 102, the processor 101 is used for executing the machine-readable instructions stored in the memory 102, and when the machine-readable instructions are executed by the processor 101, the processor 101 executes the following steps:

sending an allocation request for a hard disk memory to a memory allocator;

receiving initial address information of a first storage space returned by the memory allocator, wherein the first storage space is determined by the memory allocator based on a free memory information of the hard disk memory read from a system memory;

accessing a second storage space corresponding to the first storage space based on the initial address information of the first storage space, and reading size information of the first storage space from the second storage space, wherein the size information of the first storage space is written into the second storage space by the memory allocator; and

using the first storage space based on the initial address information and the size information.

The above memory 102 includes an internal memory 1021 and an external memory 1022; the internal memory 1021 is used for temporarily storing operational data in the processor 101 as well as data exchanged with the external memory 1022 such as hard disks, and the processor 101 exchanges data with the external memory 1022 through the internal memory 1021.

For the specific process of execution of the above-mentioned instructions, reference can be made to the steps of the memory allocation methods described in the embodiments of the present disclosure, and no redundant description is given here.

Also provided in the embodiments of the present disclosure is a computer readable storage medium. The computer readable storage medium has a computer program stored thereon, and when this computer program is run by a processor, the steps of the memory allocation methods described in the above method embodiments are executed, wherein the storage medium may be volatile or nonvolatile computer readable storage medium.

Also provided in the embodiments of the present disclosure is a computer program product that carries program codes, and instructions included in the program codes may be used to execute the steps of the memory allocation methods described in the above method embodiments. For details, reference can be made to the above method embodiments and no redundant description is given here.

Specifically, the above computer program product may be implemented in hardware, software, or a combination thereof. In an alternative embodiment, the computer program product is embodied as a computer storage medium, and in another alternative embodiment, the computer program product is embodied as a software product, e.g. software development kit (SDK) or the like.

Those skilled in the art could clearly understand that in view of the convenience and conciseness of the description, for the specific operation process of the system and apparatus described hereinabove, reference can be made to the corresponding process in the foregoing method embodiment and no redundant description is given here. In several embodiments according to the present disclosure, it should be appreciated that the disclosed systems, apparatuses and methods can be implemented in other ways. The apparatus embodiments described above are merely schematic. For example, division of the units is only a logical function division, and there may be additional division modes during actual implementation. For another example, a plurality of units or components can be combined or can be integrated into another system, or some features can be ignored, or not executed. On the other hand, mutual coupling or direct coupling or communicative connection between what is shown or discussed may be through some communication interfaces, and indirect coupling or communicative connection between the apparatuses or units may be in electrical, mechanical or other form.

The units that are illustrated as separate parts may or may not be physically separated, the parts shown as units may or may not be physical units, i.e., may be located at a place, or distributed on a plurality of network units. Some or all of these units can be selected as actually required, so as to realize the purposes of the solution of the present embodiment.

In addition, various functional units in various embodiments of the present disclosure may be integrated in a processing unit, or various units may be physically present independent of each other, or two or more than two units may be integrated in a single unit.

The function, if implemented in the form of a software function unit and sold or used as a stand-alone product, may be stored in a processor-executable nonvolatile computer-readable storage medium. Based on such understanding, the technical solution of the present disclosure or the part that contributes to the prior art or the part of this technical solution may in nature be embodied in the form of a software product, this software product is stored in a storage medium that includes several instructions for causing a computer device (which may be a personal computer, a server, or a network device, etc.) to execute all or part of the steps of the methods described in various embodiments of the present disclosure. And the aforementioned storage medium includes a variety of media that can store program codes, such as USB flash drive, portable hard drive, Read-Only Memory (ROM), Random Access Memory (RAM), magnetic disk or compact disc.

Finally, it should be noted that the above-mentioned embodiments are only specific embodiments of the present disclosure and are used to illustrate the technical solution of the present disclosure, rather than limitations thereto, and that the scope of the present disclosure is not limited to this. Although the present disclosure has been described in detail with reference to the foregoing embodiments, those ordinary skilled in the art should appreciate that within the technical scope disclosed in the present disclosure, any person skilled in the art who is familiar with the art could still modify the technical solution recited in the foregoing embodiments, or easily think of changes, or make equivalent substitutions of some of the technical features. However, these modifications, changes or substitutions do not result in a departure of the nature of the corresponding technical solution from the spirit and scope of the technical solution of the embodiments of the present disclosure, and shall be covered by the scope of the present disclosure. Therefore, the scope of the present disclosure shall be decided by the scope of the claims.

What is claimed is:

1. A method for allocating memory, comprising:
reading, in response to an allocation request for a hard disk memory sent by a target application, free memory information of the hard disk memory from a system memory;
determining, based on the free memory information of the hard disk memory, a first storage space to be allocated from the hard disk memory;
determining a second storage space corresponding to the first storage space in the hard disk memory based on initial address information of the first storage space, and writing size information of the first storage space into the second storage space; and
sending the initial address information corresponding to the first storage space to the target application, such that the target application accesses the second storage space based on the initial address information and uses the first storage space based on the size information written into the second storage space and the initial address information.

2. The method according to claim 1, wherein the hard disk memory comprises a read/write storage buffer in a hard disk.

3. The method according to claim 2, wherein the read/write storage buffer comprises a controller memory buffer (CMB) and/or a persistent memory region (PMR).

4. The method according to claim 1, wherein the free memory information of the hard disk memory comprises a plurality of lists; a list indicates memory information of various storage spaces in a free state in a continuous memory space.

5. The method according to claim 4, wherein the determining, based on the free memory information of the hard disk memory, a first storage space to be allocated from the hard disk memory comprises:
traversing the plurality of lists, and screening out the first storage space from various traversed storage spaces in the free state based on memory information of the various traversed storage spaces in the free state and requirement information indicated by the allocation request.

6. The method according to claim 1, wherein before responding to the allocation request for the hard disk memory sent by the target application, the method further comprises:
performing a free detection on the hard disk memory, and generating the free memory information of the hard disk memory; and
storing the free memory information in the system memory.

7. A method for allocating memory, comprising:
sending an allocation request for a hard disk memory to a memory allocator;
receiving initial address information of a first storage space returned by the memory allocator, wherein the first storage space is determined by the memory allocator based on a free memory information of the hard disk memory read from a system memory;
accessing a second storage space corresponding to the first storage space based on the initial address information of the first storage space, and reading size information of the first storage space from the second storage space, wherein the size information of the first storage space is written into the second storage space by the memory allocator; and
using the first storage space based on the initial address information and the size information.

8. The method according to claim 7, wherein the detail page of the target material comprises a collection control, and the method further comprises:
collecting the target material into a favorite of a material library of the first user in response to a second operation on the collection control.

9. The method according to claim 8, wherein displayed material or materials used in the virtual scene are material or materials that have been posted into the material library when the virtual scene is created.

10. The method according to claim 7, wherein the displayed material or materials used in the virtual scene are not re-created by a creator of the virtual scene, wherein material or materials are not re-created by the creator of the virtual scene comprises:
a single material composed of a plurality of geometries is not ungrouped by the creator of the virtual scene, and/or each of materials in a combined material composed of a plurality of materials is not ungrouped by the creator of the virtual scene and any one material in the combined material is not deleted.

11. A computer device, comprising at least one processor and at least one memory, wherein machine-readable instructions executable by the at least one processor are stored in the at least one memory, the at least one processor is configured for executing the machine-readable instructions stored in the at least one memory, and when the machine-readable instructions are executed by the at least one processor, the at least one processor executes a method for allocating memory, the method comprising:
reading, in response to an allocation request for a hard disk memory sent by a target application, free memory information of the hard disk memory from a system memory;
determining, based on the free memory information of the hard disk memory, a first storage space to be allocated from the hard disk memory;
determining a second storage space corresponding to the first storage space in the hard disk memory based on initial address information of the first storage space, and writing size information of the first storage space into the second storage space; and
sending the initial address information corresponding to the first storage space to the target application, such that the target application accesses the second storage space based on the initial address information and uses the first storage space based on the size information written into the second storage space and the initial address information.

12. The computer device according to claim 11, wherein the hard disk memory comprises a read/write storage buffer in a hard disk.

13. The computer device according to claim 12, wherein the read/write storage buffer comprises a controller memory buffer (CMB) and/or a persistent memory region (PMR).

14. The computer device according to claim 11, wherein the free memory information of the hard disk memory comprises a plurality of lists; a list indicates memory information of various storage spaces in a free state in a continuous memory space.

15. The computer device according to claim 14, wherein the determining, based on the free memory information of the hard disk memory, a first storage space to be allocated from the hard disk memory comprises:
traversing the plurality of lists, and screening out the first storage space from various traversed storage spaces in the free state based on memory information of the various traversed storage spaces in the free state and requirement information indicated by the allocation request.

16. The computer device according to claim 11, wherein before responding to the allocation request for the hard disk memory sent by the target application, the method further comprises:
performing a free detection on the hard disk memory, and generating the free memory information of the hard disk memory; and
storing the free memory information in the system memory.

17. A computer device, comprising at least one processor and at least one memory, wherein machine-readable instructions executable by the at least one processor are stored in the at least one memory, the at least one processor is configured for executing the machine-readable instructions stored in the at least one memory, and when the machine-readable instructions are executed by the at least one processor, the at least one processor executes the method for allocating memory according to claim 7.

18. A non-transitory computer readable storage medium, wherein the computer readable storage medium has a computer program stored thereon, and when the computer program is executed by a computer device, the computer device executes the method for allocating memory according to claim 1.

19. The non-transitory computer readable storage medium according to claim 18, wherein before responding to the allocation request for the hard disk memory sent by the target application, the method further comprises:
performing a free detection on the hard disk memory, and generating the free memory information of the hard disk memory; and
storing the free memory information in the system memory.

20. A non-transitory computer readable storage medium, wherein the computer readable storage medium has a computer program stored thereon, and when the computer program is executed by a computer device, the computer device executes the method for allocating memory according to claim 7.
